(19) United States
(12) Patent Application Publication
(10) Pub. No.: US 2026/0339644 A1
(43) Pub. Date: Oct. 29, 2026

(54) SYSTEMS AND METHODS FOR AUTOMATICALLY PATCHING STORAGE APPLIANCES IN A DISTRIBUTED NETWORK

(71) Applicant: BANK OF AMERICA CORPORATION, Charlotte, NC (US)

(72) Inventor: Gowrishankar Mookaiah, Robbinsville, NJ (US)

(73) Assignee: BANK OF AMERICA CORPORATION, Charlotte, NC (US)

(21) Appl. No.: 19/188,322

(22) Filed: Apr. 24, 2025

(51) Int. Cl. G06F 8/65

(52) U.S. Cl. CPC G06F 8/65

(57) ABSTRACT

Systems, computer program products, and methods are described herein for automatically patching storage appliances in a distributed network. The present disclosure is configured to identify at least a primary controller and a secondary controller associated with a storage application; identify a software patch for the primary controller and the secondary controller; perform a health check at the primary controller; perform failback of current resources from the primary controller to the secondary controller; update, based on the health check, the primary controller with the software patch; determine the primary controller comprises the software patch; perform, based on the current software comprising the software patch, the health check at the secondary controller; perform failback of the current resources from the secondary controller to the primary controller; and update, based on the health check at the secondary controller, the secondary controller with the software patch.

### TECHNOLOGICAL FIELD

Example embodiments of the present disclosure relate to automatically patching storage appliances in a distributed network.

### BACKGROUND

In today's network environments where storage appliances can be distributed across multiple computing components, such as multiple controllers, applying software updates or software patches to these storage applicants can be time consuming and computing resource intensive. Further, these updates often require manual intervention to start the update process and carry the update process all the way through to the end, especially across multiple controllers where a controller will have to be taken offline for the entirety of the update process, which in turn may lead to lags in up-to-date data storage between multi-controller storage applications. Thus, a great need exists for a system, computer program product, and/or computer implemented method that can efficiently, automatically, securely, and dynamically patch software updates in storage appliances in a distributed network.

Applicant has identified a number of deficiencies and problems associated with automatically patching storage appliances in a distributed network. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for automatically patching storage appliances in a distributed network.

In one aspect, a system for automatically patching storage appliances in a distributed network is provided. In some embodiments, the system may comprise: a processing device; a non-transitory storage device containing instructions when executed by the processing device, causes the processing device to perform the steps of: identify at least a primary controller and a secondary controller associated with a storage application; identify a software patch for the primary controller and the secondary controller; perform a health check at the primary controller; perform failback of current resources from the primary controller to the secondary controller; update, based on the health check at the primary controller, the primary controller with the software patch; determine a current software of the primary controller comprises the software patch; perform, in response to the current software comprising the software patch, the health check at the secondary controller; perform, in response to the health check at the secondary controller, failback of the current resources from the secondary controller to the primary controller; and update, based on the health check at the secondary controller, the secondary controller with the software patch.

In some embodiments, the primary controller and the secondary controller are active-active.

In some embodiments, the update of the primary controller is performed in parallel to the failback of the current resources from the primary controller to the secondary controller.

In some embodiments, the update of the secondary controller is performed in parallel to the failback of the current resources from the secondary controller to the primary controller.

In some embodiments, the update of the primary controller is performed in response to the failback of the current resources from the primary controller to the secondary controller.

In some embodiments, the update of the secondary controller is performed in response to the failback of the current resources from the secondary controller to the primary controller.

In some embodiments, executing the instructions further causes the processing device to: validate a cluster status of the primary controller and the secondary controller associated with the storage application, wherein the cluster status comprises historical software of the primary controller and the secondary controller.

In some embodiments, executing the instructions further causes the processing device to: validate, in response to updating the primary controller, a peer status between the primary controller and the secondary controller; and validate, in response to updating the secondary controller, the peer status between the secondary controller and the primary controller. In some embodiments, executing the instructions further causes the processing device to: update, in response to the validation of the peer status and in response to updating the primary controller, firmware at the primary controller; and update, in response to the validation of the peer status and in response to updating the secondary controller, firmware at the secondary controller.

In some embodiments, executing the instructions further causes the processing device to: determine a current software of the secondary controller comprises the software patch; and perform failback of current resources from the primary controller back to the secondary controller.

In some embodiments, executing the instructions further causes the processing device to: generate, based on the update of the secondary controller, a report interface component comprising data corresponding to the software patch updated in the primary controller and the secondary controller.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for automatically patching storage appliances in a distributed network, in accordance with an embodiment of the disclosure;

FIG. 2 illustrates a process flow for automatically patching storage appliances in a distributed network, in accordance with an embodiment of the disclosure;

FIG. 3 illustrates a process flow for validating a cluster status of the primary controller and the secondary controller, in accordance with an embodiment of the disclosure;

FIG. 4 illustrates a process flow for validating a peer status for the primary controller and the secondary controller, and updating firmware of the primary controller and the secondary controller, in accordance with an embodiment of the disclosure;

FIG. 5 illustrates a flow diagram for performing a failback of the current resources from the primary controller back to the secondary resource and for generating a report interface component once the primary controller and secondary controller have been updated, in accordance with an embodiment of the disclosure; and

FIG. 6 an exemplary architecture diagram for automatically patching storage appliances in a distributed network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In today's network environments where storage appliances can be distributed across multiple computing components, such as multiple controllers, applying software updates or software patches to these storage applicants can be time consuming and computing resource intensive. Further, these updates often require manual intervention to start the update process and carry the update process all the way through to the end, especially across multiple controllers where a controller will have to be taken offline for the entirety of the update process, which in turn may lead to lags in up-to-date data storage between multi-controller storage applications. Thus, a great need exists for a system, computer program product, and/or computer implemented method that can efficiently, automatically, securely, and dynamically patch software updates in storage appliances in a distributed network. Such problems are prevalent in storage applications that comprise two controllers where resources are equally shared among them, and to patch these storage applications, resources would need to be failed over to the other controller and then failed back after completion.

Accordingly, the present disclosure provides for the identification of at least a primary controller and a secondary controller associated with a storage application; the identification of a software patch for the primary controller and the secondary controller; the performance of a health check at the primary controller; the performance of failback of current resources from the primary controller to the secondary controller; and the update, based on the health check at the primary controller, of the primary controller with the software patch. Further, the disclosure provides for the determination of a current software of the primary controller comprises the software patch; the performance, in response to the current software comprising the software patch, of the health check at the secondary controller; the performance, in response to the health check at the secondary controller, of failback of the current resources from the secondary controller to the primary controller; and the update, based on the health check at the secondary controller, of the secondary controller with the software patch. In some embodiments, the disclosure may further provide for the generation, based on the update of the secondary controller, of a report interface component comprising data corresponding to the software patch updated in the primary controller and the secondary controller.

In other words, the disclosure provides a system for automatically applying patches to storage appliances. The system comprises two controllers for failover control as the patches are applied using a step-by-step process between the two controllers. Thus, and importantly, the process of patching the appliances comprises performing health checks and validating all the components at a first controller prior to failover of resources to the second controller while the first controller is updated, and then once the first controller has been updated, failback of the resources back to the first controller may occur. Importantly, the disclosure provided herein allows for easy and quick patching of these storage appliances, while allowing for improved operational efficiency, reducing likelihood of errors while ensuring that the storage appliances are always running the latest software versions for optimal performance and security.

What is more, the present disclosure provides a technical solution to a technical problem. As described herein, the technical problem includes the automatic patching of storage appliances in a distributed network. The technical solution presented herein allows for the automatic, efficient, secure, and dynamic application of software patches to multiple controller storage applications in a distributed network without manual intervention. In particular, the disclosure provided herein is an improvement over existing solutions to the software patching, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

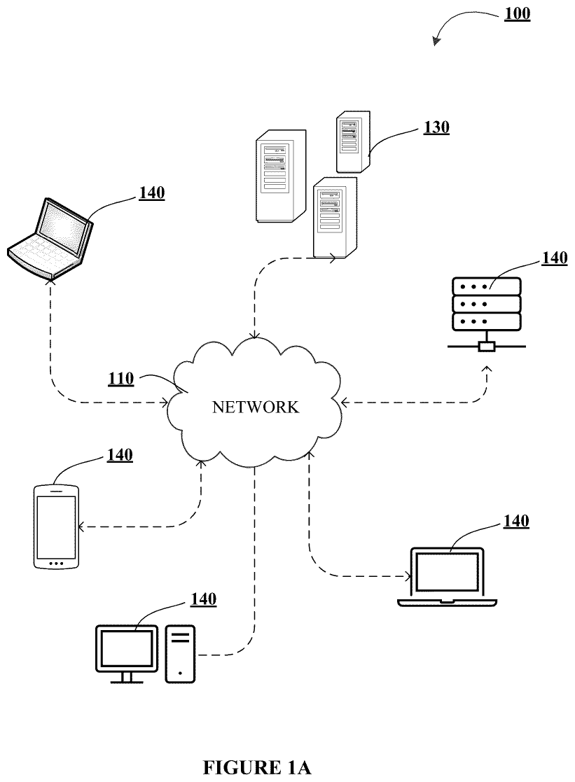

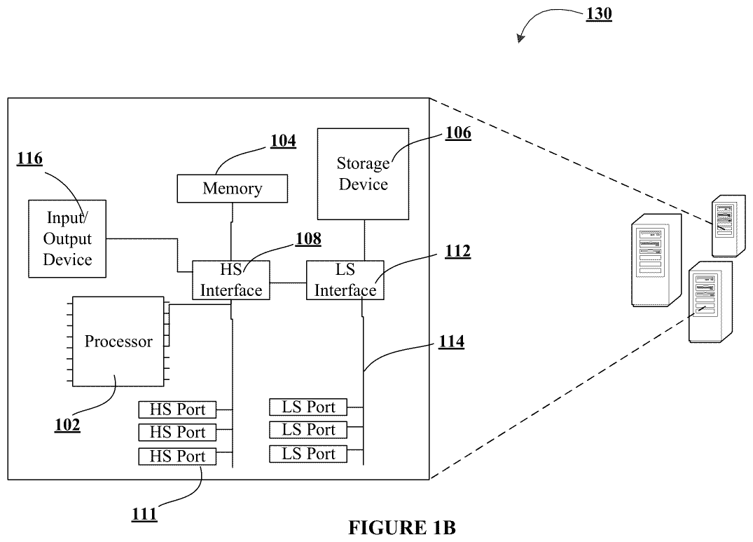

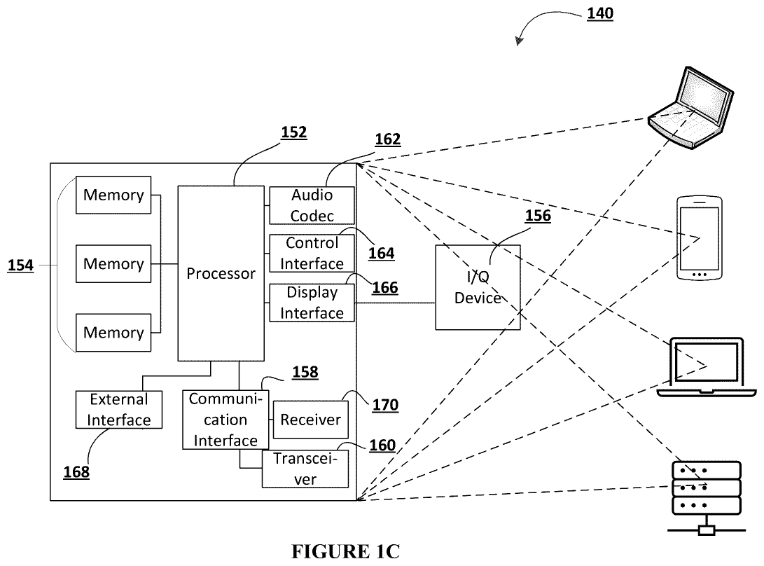

FIGS. 1A-1C illustrate technical components of an exemplary distributed computing environment for automatically patching storage appliances in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

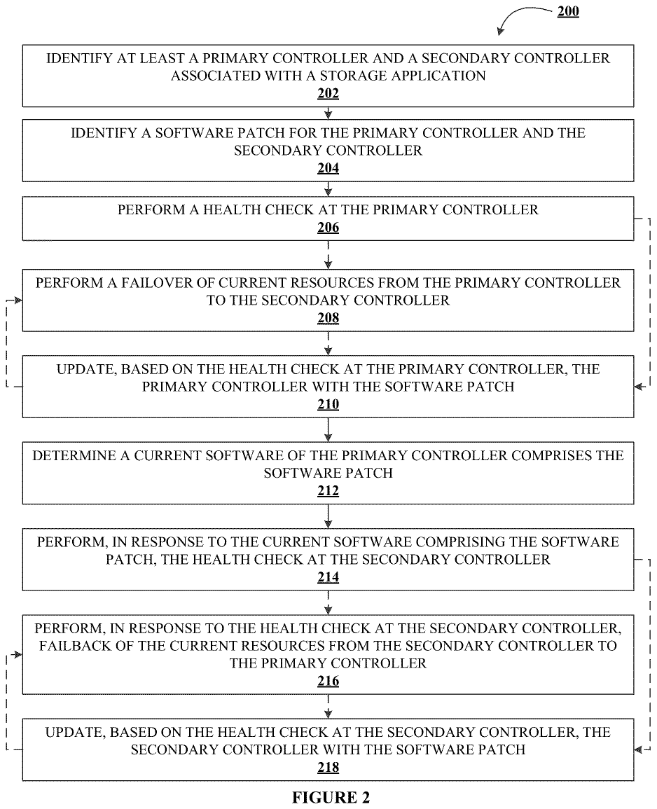

FIG. 2 illustrates a process flow 200 for data transmissions using near field communication and secure image generation in offline environments, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of identifying at least a primary controller and a secondary controller associated with a storage application. As used herein, the term “controller” refers to a computing component configured to manage the data flow between a storage appliance (i.e., storage application or device) and a secondary or host system. Such a controller may be configured to read and write data, correct any errors, and retrieve data from the storage appliance. In some embodiments, such a storage appliance may comprise multiple controllers, or dual controllers (e.g., a primary controller, a secondary controller, and/or the like). As used herein, the term's “primary” and “secondary” with respect to “primary controller” and “secondary controller” are meant to differentiate between the two controllers, but are not meant to portray a preferred controller over the other controller. For example, such a primary controller and secondary controller may refer to identical storage controllers which are used for redundancy and always ensure availability for the storage appliance and host system. Thus, and where one controller fails, the other controller may take over, and prevent data loss, data lag, and service interruption.

In some embodiments, the primary controller and the secondary controller may be identified by the system based on the system identifying the associated storage appliance. In some such embodiments, the storage appliance may be identified by the system itself based on receiving or identifying a software patch or update for the storage appliance, based on an owner or operator of the storage appliance identifying a software patch or update, based on a threshold time being met between software patches or updates to a storage appliance (e.g., threshold time may be measured between the previous update or patch to the storage appliance and a current time), and/or the like.

As shown in block 204, the process flow 200 may include the step of identifying a software patch for the primary controller and the secondary controller. For example, such a software patch refers to a small or big update to a storage appliance to fix errors or bugs, improve security, add new components or features, and/or the like, to the storage appliance. Thus, and based on identifying the software patch for the storage appliance, the software patch may be identified as applicable to the primary controller and secondary controller associated with the storage appliance. In some embodiments, the software patch may be identified based on the system automatically identifying an available or new software patch that has not already been applied to the primary controller and secondary controller. In some embodiments, the system may allow the automatic upload of the software patch to the primary controller and/or secondary controller. In some embodiments, the system may download the software patch to the primary controller and/or secondary controller from a server associated with the software patch generator.

As shown in block 206, the process flow 200 may include the step of performing a health check at a primary controller. For example, the system may perform a health check at the primary controller, and such a health check may comprise a check of the primary controller's hardware and/or a check on the primary controller's current operational status, connectivity, ability to complete requests, and/or ability to perform specific functions. In this manner, the health check of the primary controller is meant to determine if the primary controller can handle current network traffic and the hardware components are acting in accordance with their intended purpose (e.g., no interruptions, unexpected downtime, and/or the like).

In some embodiments, the health check may comprise a health indicator for the primary controller, wherein the health indicator shows the primary controller is performing as expected (e.g., a positive health indicator) or the primary controller is not performing as expected (e.g., a negative health indicator). In some embodiments, the process described hereinbelow may only continue in an instance where the health indicator is a positive health indicator.

As shown in block 208, the process flow 200 may include the step of performing a failback of current resources from the primary controller to the secondary controller. For instance, the system may perform a failback operation for the resources of the primary controller to a secondary controller. In this manner, the secondary controller may take on the resources and perform the functions of both the primary controller and the secondary controller while the primary controller is being updated. Such a failback may comprise switching operations and resources of from one controller to another controller, here switching operations and resources from the primary controller to the secondary controller. Further, and as used herein, “resources” may refer to data and/or network traffic serviced by the primary controller and/or the secondary controller.

As shown in block 210, the process flow 200 may include the step of updating, based on the health check at the primary controller, the primary controller with the software patch. For example, the system may update—using the software patch identified and after confirming the health of the primary controller—the primary controller with the software patch. Such an update may comprise triggering the installation of the software patch at the primary controller after the system has determined the failover of resources and/or operations has occurred and the secondary controller is operating with the resources and operations of the primary controller. Thus, and importantly, the storage appliance will remain operational using the secondary controller, even as the primary controller is undergoing an update.

In some embodiments, the update of the primary controller is performed in parallel to the failover of the current resources from the primary controller to the secondary controller. For instance, and in some such embodiments, the system may automatically trigger both the failover of the resources and operations from the primary controller to the secondary controller in real time or near real time to the primary controller going offline for updating. Alternatively, and in some embodiments, the update of the primary controller is performed in response to the failover of the current resources from the primary controller to the secondary controller. For example, the system may automatically trigger the update of the primary controller in real time or near real time to the failover of the resources and/or operations from eh primary controller to the secondary controller.

As shown in block 212, the process flow 200 may include the step of determining a current software of the primary controller comprises the software patch. For example, the system may determine the software patch has been properly applied to the primary controller and the primary controller has been updated based on accessing the current software of the primary controller and determining the current software comprises the software patch. In some embodiments, the current software may comprise a version identifier, and the system may determine the version identifier for the current software matches a version identifier for the software patch. Such a version identifier may comprise a unique string of alphanumeric characters which uniquely identifies the version of the latest software of the primary controller.

As shown in block 214, the process flow 200 may include the step of performing, in response to the current software comprising the software patch, the health check at the secondary controller. For instance, the system may additionally perform a health check on the secondary controller after the primary controller has been updated and before the secondary controller can be updated with the software patch. For example, such a health check for the secondary controller may comprise the same steps or process as the health check described above with respect to the primary controller. Like the health check of the primary controller, the health check may comprise a health indicator which may be used to show the current health of the secondary controller (e.g., positive or negative). In some such embodiments, only when the health indicator is a positive health indicator may the secondary controller be updated with the software patch.

As shown in block 216, the process flow 200 may include the step of performing, in response to the health check at the secondary controller, failback of the current resource from the secondary controller to the primary controller. Thus, and in other words, once the system has determined the health of the secondary controller (e.g., that the secondary controller is operating as expected), the system may trigger a failback of the resources and operations previously run by the primary controller as well as any resources and operations that were run by the secondary controller. In this manner, all the resources and operations from the secondary controller will be failed over or failed back to the primary controller while the secondary controller is updated.

As shown in block 218, the process flow 200 may include the step of updating, based on the health check at the secondary controller, the secondary controller with the software patch. For example, and similar to the update of the primary controller, the secondary controller may also be updated by applying the software patch to the secondary controller in the same manner as the application of the software patch to the primary controller.

In some embodiments, the update of the secondary controller is performed in parallel to the failback of the current resources from the secondary controller to the primary controller. For example, the update of the secondary controller may be triggered in real time or near real time to the failover/failback of the current resources and operations from the secondary controller to the primary controller. Thus, and importantly, by performing the updates in parallel to the failover/failback of resources and operations between the controllers, the system ensures efficiency in updating the controllers while maintaining normal operation for the storage appliance.

In some embodiments, the update of the secondary controller is performed in response to the failback of the current resources from the secondary controller to the primary controller. For example, the system may update the secondary controller only once the failover/failback of the resources and/or operations from the secondary controller to the primary controller has occurred.

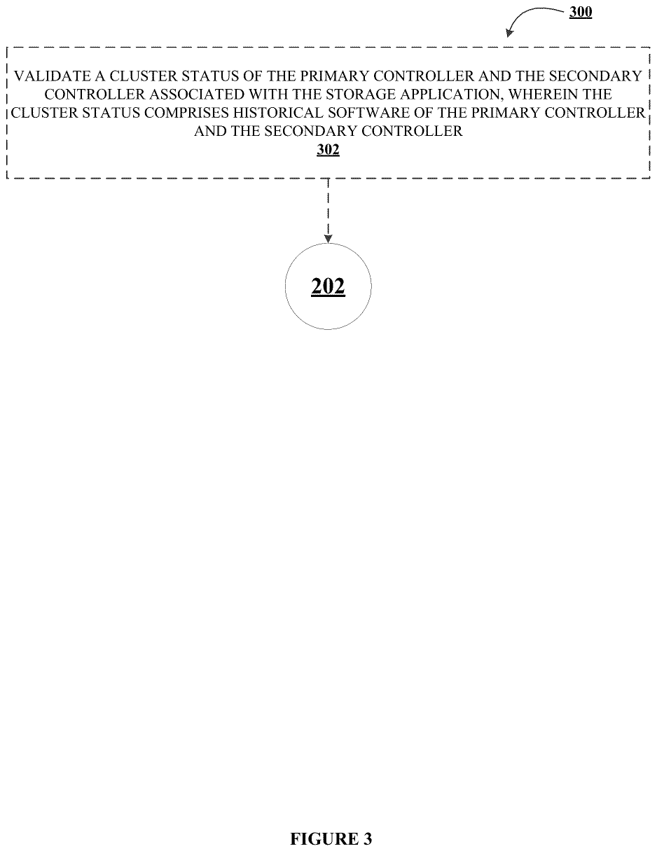

FIG. 3 illustrates a process flow 300 for validating a cluster status of the primary controller and the secondary controller, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of validating a cluster status of the primary controller and the secondary controller associated with the storage application, wherein the cluster status comprises historical software to the primary controller and the secondary controller. For example, the system may validate the cluster of controllers associated with the storage appliance, such that each controller for the storage appliance is identified and updated with the software patch. In some embodiments, the cluster status may comprise historical software for both controllers to determine that the controllers are active-active controllers (i.e., always on) and comprise the same historical resources for the storage appliance. In some embodiments, the system may validate the cluster of the primary controller, and the secondary controller based on identifying the shared historical resources (e.g., historical data) between the primary controller and the secondary controller. In some such embodiments, the validation of the cluster may occur so the system can identify all the controllers associated with the storage appliance that will need to be updated with the software patch. In some embodiments, the cluster status may be used to determine the overall health of all the controllers in the cluster, such as by the historical data shared between the primary controller and the secondary controller.

In some embodiments, and as shown in process flow 300, this validation of the cluster of controllers may occur before the process described herein with respect to block 202.

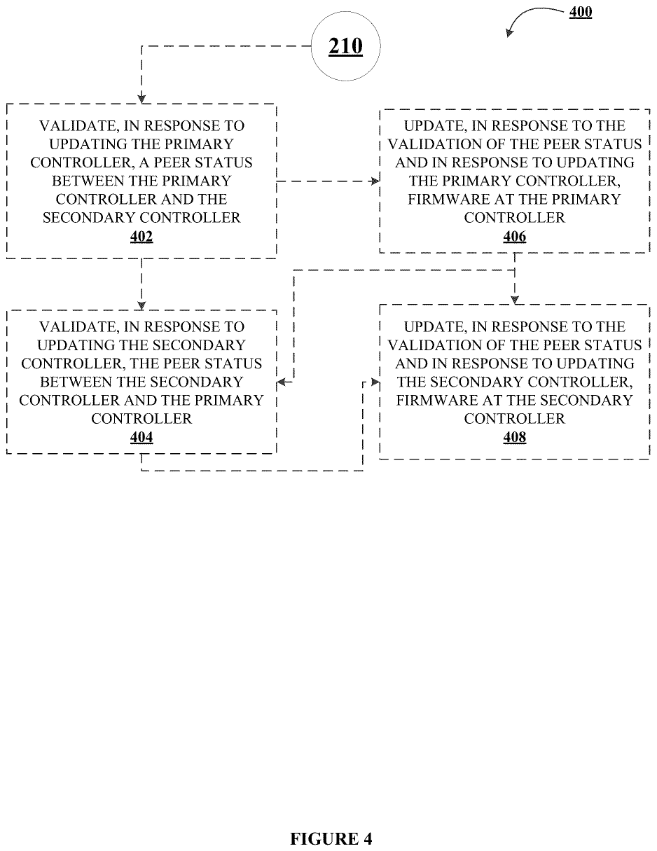

FIG. 4 illustrates a process flow 400 for validating a peer status for the primary controller and the secondary controller, and updating firmware of the primary controller and the secondary controller, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 200 may include the step of validating, in response to updating the primary controller, a peer status between the primary controller and the secondary controller. For example, the system may validate, once the primary controller has been updated with the software patch, connection(s) between the primary controller and the secondary controller are still intact. In some embodiments, such a connection may refer to the ability for the primary controller and secondary controller to communicate and take over resources and/or operations in an instance where either the primary controller or secondary controller cannot perform their respective operations. Additionally, and/or alternatively, the system may validate the cluster status for the primary controller and the secondary controller based on the historical and/or current communication between the controllers.

In some embodiments, and as shown in the process flow 400, the process described herein may occur after the process of block 210.

In some embodiments, and as shown in block 404, the process flow 400 may include the step of validating, in response to updating the secondary controller, the peer status between the secondary controller and the primary controller. For example, and in some such embodiments, the system may validate the secondary controller shares a peer status with the primary controller after the secondary controller has been updated.

In this manner, and after updating each controller, the system may validate that the peer status between the controllers has not changed. Therefore, the system may determine the controllers are still connected and can communicate, and thus, can still perform failover and failback operations when necessary.

In some embodiments, and as shown in block 406, the process flow 400 may include the step of updating, in response to the validation of the peer status and in response to updating the primary controller, firmware at the primary controller. For instance, and in some embodiments, the system may update—in response to the validation of the peer status after the primary controller has been updated—firmware of the primary controller. Such firmware update may comprise upgrading software and/or hardware in response to the newly updated software from the software patch. In some embodiments, the firmware used in the update may be associated with and/or packaged with the software patch used to update the primary and secondary controllers.

In some embodiments, and as shown in block 408, the process flow 400 may include the step of updating, in response to the validation of the peer status and in response to updating the secondary controller, firmware at the secondary controller. Similar to the updating of the firmware in the primary controller, the system may also update the firmware for the secondary controller in response to validating the peer status and updating the secondary controller with the software patch.

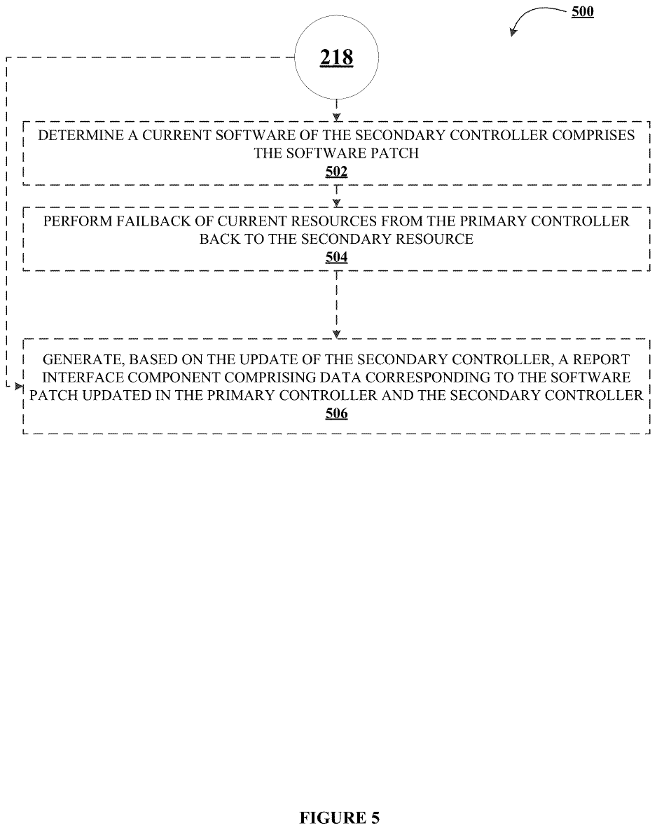

FIG. 5 illustrates a process flow 500 for performing a failback of the current resources from the primary controller back to the secondary resource and for generating a report interface component once the primary controller and secondary controller have been updated, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of determining a current software of the secondary controller comprises the software patch. For example, and in some such embodiments, the system may determine a current software of the secondary controller comprises the software patch in the same manner as the system determined the current software of the primary controller comprised the software patch as explained in FIG. 2.

In some embodiments, the process described herein for process flow 500 may occur after the process described hereinabove with respect to FIG. 2.

In some embodiments, and as shown in block 504, the process flow 500 may include the step of performing failback of current resources from the primary controller back to the secondary controller. For example, and in some such embodiments, the system may perform a failback of the resources and operations from the primary controller back to the secondary controller, wherein the failback of these resources and operations may comprise the resources and operations that were previously handled by the secondary controller when both the primary and secondary controller were operational and operating normally. In this manner, the failback of the current resources from the primary controller back to the secondary controller may act to bring the primary controller and secondary controller back to their original and normal operations and resources (e.g., when both controllers are operating normally, and no resources or operations are undergoing a failover or failback).

In some embodiments, and as shown in block 506, the process flow 500 may include the step of generating, based on the update of the secondary controller, a report interface component comprising data corresponding to the software patch updated in the primary controller and the secondary controller. For example, and in some embodiments, the system may generate a report interface component indicating the success of the update of both the primary controller and the secondary controller with the software patch. In some such embodiments, the report interface component may comprise computer-readable data used to configure a receiving user device's graphical user interface (GUI) with human-readable information indicating the status of the software patch (e.g., if the software patch was successful across all the controllers for the storage appliance). In some embodiments, the report interface component may comprise information indicating the success of any firmware updates that may have also been applied to the controller(s) and/or computing components associated with the storage appliance.

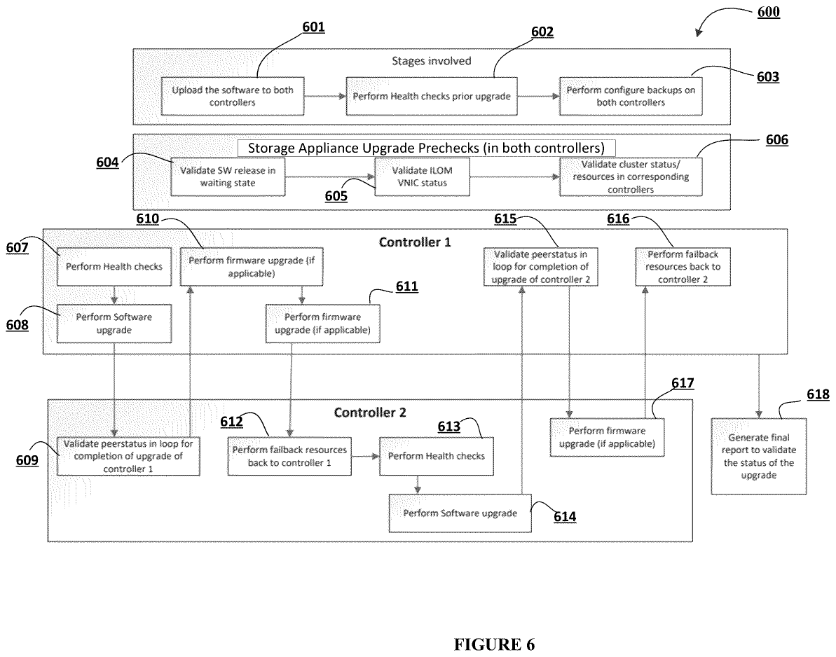

FIG. 6 illustrates an exemplary architecture flow 600 for automatically patching storage appliances in a distributed network, in accordance with an embodiment of the disclosure. In some embodiments, a system (e.g., similar to one or more of the systems described herein with respect to FIGS. 1A-1C) may perform one or more of the steps of architecture flow 600. For example, a system (e.g., the system 130 described herein with respect to FIG. 1A-1C) may perform the steps of architecture flow 600.

As shown in architecture flow 600, the system described herein may comprise a general process of blocks 601-606. For example, the system may identify software patch for a storage application. In some embodiments, the process of identifying the software patch may comprise automatically uploading the software to both controllers 601 (e.g., the primary and secondary controller). The system may then perform health checks on both the controllers prior to upgrade 602. Further, and as shown at 603, the system may perform a configuration of backups on both controllers, which will determine the controllers will act as backup controllers for each other when the other controller is down due to its update. As shown at 604-606, the system may perform pre-checks at both controllers before the controllers can be updated. For instance, and at block 604, the system may validate the software patch is in a waiting state at both controllers until the steps described with respect to blocks 607-613 occur. In some embodiments, the system may validate the status of connectivity for each controller, such the connection to a manager for servers (e.g., ILOM® for an Oracle® ZFS® system) which can provide a remote monitor for the servers in communication with the controllers, and/or for the controllers themselves, and the system may validate a network interface connection (e.g., virtual network interface connection or VNIC) for the controllers, which is shown at 605. As shown at 606, the system may validate the cluster status and resources corresponding to the controllers, as a whole for the cluster and/or individually for each controller.

As shown in controller 1 (or the primary controller), the system may perform a health check at 607. Upon performing the health check, the system may then perform a software upgrade with the software patch at controller 1, as shown at 608. In some embodiments, and in parallel to or before the software upgrade of 608, the system may perform a failover of the operations and/or resources from the primary controller to the secondary controller. As shown at 609, the system may validate a peer status in a loop for the completion of the upgrade to controller 1. For example, the system may continually monitor and continually validate the peer status of controller 1 with controller 2 while controller 1 is updating and up until controller 1 has been updated. In this manner, the system can confirm controller 1 and controller 2 remain connected and in communication. Further, and as shown at 610, the system may perform a firmware upgrade if there is a firmware upgrade available or necessary for the controllers. In some embodiments, and where a firmware upgrade is not applicable, the process may be streamlined between 609 and 612. In some embodiments, and where the firmware upgrade is applicable, the system may perform the firmware upgrade on controller 1 directly after controller 1 has been updated, but before the operations and/or resources have been failed back to controller 1.

As shown at 612, and once controller 1 has been updated, the system may perform the failback of resources (and/or operations) back to controller 1. Further, and in some embodiments, such a failback of resources may comprise a failover of resources previously operated by controller 2 when both controllers 1 and 2 were operational. As shown at 613, the system may perform a health check of controller 2 in a similar manner as the health check performed for controller 1 at 607. As shown at 614, and once the health check has been performed, the system may perform the software upgrade at controller 2. Similar to the validation of peer status that occurred for controller 1 when controller 1 was being updated, the system may also validate the peer status between controller 2 and controller 1 in loop until completion of the upgrade to controller 2, as shown at 615. Similar to the firmware upgrade of controller 1, and as shown at 617, the system may also perform the firmware upgrade of controller 2, when applicable. Importantly, and upon updating controller 2, the system may perform the failback of resources (and/or operations) back to controller 2. Thus, and once both controllers have been updated, the resources and/or operations may return to their respective controllers in active-active states. In some embodiments, and as shown at 618, the system may generate a final report (e.g., a report interface component) to validate the status of the upgrade for both controllers, and thus, for the storage appliance.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for automatically patching storage appliances in a distributed network, the system comprising:
a processing device;
a non-transitory storage device containing instructions when executed by the processing device, causes the processing device to perform the steps of:
identify at least a primary controller and a secondary controller associated with a storage application;
identify a software patch for the primary controller and the secondary controller;
perform a health check at the primary controller;
perform failover of current resources from the primary controller to the secondary controller;
update, based on the health check at the primary controller, the primary controller with the software patch;
determine a current software of the primary controller comprises the software patch;
perform, in response to the current software comprising the software patch, the health check at the secondary controller;
perform, in response to the health check at the secondary controller, failback of the current resources from the secondary controller to the primary controller; and
update, based on the health check at the secondary controller, the secondary controller with the software patch.

2. The system of claim 1, wherein the primary controller and the secondary controller are active-active.

3. The system of claim 1, wherein the update of the primary controller is performed in parallel to the failback of the current resources from the primary controller to the secondary controller.

4. The system of claim 1, wherein the update of the secondary controller is performed in parallel to the failback of the current resources from the secondary controller to the primary controller.

5. The system of claim 1, wherein the update of the primary controller is performed in response to the failback of the current resources from the primary controller to the secondary controller.

6. The system of claim 1, wherein the update of the secondary controller is performed in response to the failback of the current resources from the secondary controller to the primary controller.

7. The system of claim 1, wherein executing the instructions further causes the processing device to:
validate a cluster status of the primary controller and the secondary controller associated with the storage application, wherein the cluster status comprises historical software of the primary controller and the secondary controller.

8. The system of claim 1, wherein executing the instructions further causes the processing device to:
validate, in response to updating the primary controller, a peer status between the primary controller and the secondary controller; and
validate, in response to updating the secondary controller, the peer status between the secondary controller and the primary controller.

9. The system of claim 8, wherein executing the instructions further causes the processing device to:
update, in response to the validation of the peer status and in response to updating the primary controller, firmware at the primary controller; and
update, in response to the validation of the peer status and in response to updating the secondary controller, firmware at the secondary controller.

10. The system of claim 1, wherein executing the instructions further causes the processing device to:
determine a current software of the secondary controller comprises the software patch; and
perform failback of current resources from the primary controller back to the secondary controller.

11. The system of claim 1, wherein executing the instructions further causes the processing device to:
generate, based on the update of the secondary controller, a report interface component comprising data corresponding to the software patch updated in the primary controller and the secondary controller.

12. A computer program product for automatically patching storage appliances in a distributed network, wherein the computer program product comprises at least one non-transitory computer-readable medium having computer-readable program code portions embodied therein, the computer-readable program code portions which when executed by a processing device are configured to cause the processor to:
identify at least a primary controller and a secondary controller associated with a storage application;
identify a software patch for the primary controller and the secondary controller;
perform a health check at the primary controller;
perform failback of current resources from the primary controller to the secondary controller;
update, based on the health check at the primary controller, the primary controller with the software patch;
determine a current software of the primary controller comprises the software patch;
perform, in response to the current software comprising the software patch, the health check at the secondary controller;
perform, in response to the health check at the secondary controller, failback of the current resources from the secondary controller to the primary controller; and
update, based on the health check at the secondary controller, the secondary controller with the software patch.

13. The computer program product of claim 12, wherein the computer-readable program code portions which when executed by the processing device are configured to cause the processor to:
validate a cluster status of the primary controller and the secondary controller associated with the storage application, wherein the cluster status comprises historical software of the primary controller and the secondary controller.

14. The computer program product of claim 12, wherein the computer-readable program code portions which when executed by the processing device are configured to cause the processor to:
validate, in response to updating the primary controller, a peer status between the primary controller and the secondary controller; and
validate, in response to updating the secondary controller, the peer status between the secondary controller and the primary controller.

15. The computer program product of claim 14, wherein the computer-readable program code portions which when executed by the processing device are configured to cause the processor to:
update, in response to the validation of the peer status and in response to updating the primary controller, firmware at the primary controller; and
update, in response to the validation of the peer status and in response to updating the secondary controller, firmware at the secondary controller.

16. The computer program product of claim 12, wherein the computer-readable program code portions which when executed by the processing device are configured to cause the processor to:
determine a current software of the secondary controller comprises the software patch; and
perform failback of current resources from the primary controller back to the secondary controller.

17. A computer implemented method for automatically patching storage appliances in a distributed network, the computer implemented method comprising:
identifying at least a primary controller and a secondary controller associated with a storage application;
identifying a software patch for the primary controller and the secondary controller;
performing a health check at the primary controller;
performing failback of current resources from the primary controller to the secondary controller;
updating, based on the health check at the primary controller, the primary controller with the software patch;
determining a current software of the primary controller comprises the software patch;
performing, in response to the current software comprising the software patch, the health check at the secondary controller;
performing, in response to the health check at the secondary controller, failback of the current resources from the secondary controller to the primary controller; and
updating, based on the health check at the secondary controller, the secondary controller with the software patch.

18. The computer implemented method of claim 17, further comprising:
validating a cluster status of the primary controller and the secondary controller associated with the storage application, wherein the cluster status comprises historical software of the primary controller and the secondary controller.

19. The computer implemented method of claim 17, further comprising:
validating, in response to updating the primary controller, a peer status between the primary controller and the secondary controller; and
validating, in response to updating the secondary controller, the peer status between the secondary controller and the primary controller.

20. The computer implemented method of claim 19, further comprising:
updating, in response to the validation of the peer status and in response to updating the primary controller, firmware at the primary controller; and
updating, in response to the validation of the peer status and in response to updating the secondary controller, firmware at the secondary controller.
